(19) United States
(12) Patent Application Publication
(10) Pub. No.: US 2022/0105506 A1
(43) Pub. Date: Apr. 7, 2022

(54) FLUID-HANDLING SYSTEM AND CARTRIDGE

(71) Applicant: Enplas Corporation, Kawaguchi-shi, Saitama (JP)

(72) Inventor: Takumi Yamauchi, Saitama (JP)

(21) Appl. No.: 17/426,665

(22) PCT Filed: Jan. 28, 2020
(86) PCT No.: PCT/JP2020/002919

§ 371 Date: Jul. 29, 2021

(30) Foreign Application Priority Data
Feb. 1, 2019 (JP) 2019-016903

(51) Int. Cl. B01L 3/00

(52) U.S. Cl. CPC B01L 3/502; B01L 2200/025; B01L 2200/026; B01L 2200/04; B01L 2200/16; B01L 2400/0633; B01L 2300/049; B01L 2300/0609; B01L 2300/0867; B01L 2300/123; B01L 2300/042

(57) ABSTRACT

A fluid-handling system has: a reservoir; a channel chip; and a cap in which a first end is fitted into an opening of the reservoir and a second end is connected to an introduction port of the channel chip, the cap having a through hole connecting the first end and the second end. The reservoir has a first engaging part, and the channel chip has a second engaging part. The first engaging part of the reservoir and the second engaging part of the channel chip are in a first engaging state when the cap is closed. The first engaging part of the reservoir and the second engaging part of the channel chip are in a second engaging state when the cap is open.

### TECHNICAL FIELD

The present invention relates to a fluid handling system and a cartridge.

### BACKGROUND ART

In the related art, when testing or analyzing various fluids, it has been common practice to suction the required amount of sample from the container used to store the fluid (sample) using a pipette, etc., and inject it into a chip or device for analysis. In the related art, devices that can automatically suction samples by pipette and inject samples into chips have been proposed (e.g., PTL 1 and PTL 2).

### CITATION LIST

### Patent Literature

### PTL 1

### Japanese Patent Application Laid-Open No. 2013-150634

### PTL 2

### WO2013/088913

### SUMMARY OF INVENTION

### Technical Problem

However, the analyzing devices described in PTL 1 and PTL 2 require a means to suction a sample into a pipette and a means to move the pipette. In addition, a plurality of pipettes is needed to inject a plurality of samples and reagents into the chips, and a plurality of pipettes also needed to be controlled. As a result, the device tends to be large and costly.

In view of the above, an object of the present invention is to provide a fluid handling system that can reliably inject fluid to a desired channel chip without using large-scale devices. In addition, another object of the present invention is to provide a cartridge that can be used in the above-mentioned fluid handling system.

### Solution to Problem

A fluid handling system according to an embodiment of the present invention includes: a reservoir including a housing part configured to house fluid, an opening disposed in a bottom of the housing part and configured to communicate between the housing part and outside, and a first engaging part; a channel chip including an inlet disposed opposite to the opening of the reservoir and configured to introduce fluid, and a second engaging part configured to engage with the first engaging part; and a cap made of elastomer with flexibility, the cap including a first end portion configured to be fit in the opening of the reservoir, a second end portion configured to be connected to the inlet of the channel chip, and a through hole configured to connect the first end portion and the second end portion. A closed state is set when the opening of the reservoir presses a part of the cap in such a manner as to close the through hole, the closed state being a state where fluid in the housing part does not move to the inlet of the channel chip through the through hole of the cap. An open state is set when the cap is moved to a side of the housing part relative to a position of the closed state and pressing of the opening against the cap is released, the open state being a state where the fluid in the housing part moves to the inlet of the channel chip through the through hole of the cap. In the closed state, the first engaging part of the reservoir and the second engaging part of the channel chip are in a first engaging state. In the open state, the first engaging part of the reservoir and the second engaging part of the channel chip are in a second engaging state. When at least one of the reservoir and the channel chip is moved in such a manner that the reservoir and the channel chip are brought closer to each other, an engaging state of the first engaging part and the second engaging part is switched from the first engaging state to the second engaging state.

A cartridge according to an embodiment of the present invention is configured to be used in combination with a channel chip including an inlet configured to introduce fluid and a second engaging part, the cartridge including: a reservoir including a housing part configured to house fluid, an opening disposed in a bottom of the housing part and configured to communicate between the housing part and outside, and a first engaging part configured to be engaged with the second engaging part; and a cap made of elastomer with flexibility, the cap including a first end portion configured to be fit in the opening of the reservoir, a second end portion configured to be connected to the inlet of the channel chip, and a through hole configured to connect the first end portion and the second end portion. A closed state is set when the opening of the reservoir presses a part of the cap in such a manner as to close the through hole, the closed state being a state where fluid in the housing part does not move to the inlet of the channel chip through the through hole of the cap. An open state is set when the cap is moved to a side of the housing part relative to a position of the closed state and pressing of the opening against the cap is released, the open state being a state where the fluid in the housing part moves to the inlet of the channel chip through the through hole of the cap. The first engaging part of the reservoir is configured such that in the closed state, the first engaging part and the second engaging part of the channel chip are in a first engaging state. The first engaging part of the reservoir is configured such that in the open state, the first engaging part and the second engaging part of the channel chip are in a second engaging state. The first engaging part is configured such that when at least one of the reservoir and the channel chip is moved in such a manner that the reservoir and the channel chip are brought closer to each other, an engaging state of the first engaging part and the second engaging part is switched from the first engaging state to the second engaging state.

### Advantageous Effects of Invention

According to the present invention, a fluid handling system that can inject fluid to a channel chip by a simple method without using a means that drives a pipette or a means that conveys a chip can be provided. In addition, according to the present invention, a cartridge that can be used in the above-mentioned fluid handling system can be provided.

### BRIEF DESCRIPTION OF DRAWINGS

FIG. 1 is a perspective view of a fluid handling system according to an embodiment of the present invention;

FIG. 2 is an exploded perspective view of the fluid handling system according to the present embodiment;

FIG. 3A is an exploded front view of the fluid handling system according to the present embodiment, and FIG. 3B is a right side view of the fluid handling system according to the present embodiment;

FIGS. 4A to 4D illustrate a configuration of the fluid handling system according to the present embodiment in a closed state;

FIGS. 5A to 5D illustrate a configuration of the fluid handling system according to the present embodiment in an open state;

FIGS. 6A to 6D illustrate a configuration of a reservoir;

FIGS. 7A to 7D illustrate a configuration of a reservoir;

FIGS. 8A and 8B illustrate a configuration of a reservoir;

FIGS. 9A to 9F illustrate a configuration of a cap;

FIGS. 10A to 10C illustrate a configuration of a channel chip; and

FIG. 11 is a bottom view of a main body of a channel chip.

### DESCRIPTION OF EMBODIMENTS

A fluid handling system according to an embodiment of the present invention is elaborated below with reference to the drawings. Note that the dimensions or proportions of dimensions shown in the drawings may differ from the actual dimensions or proportions of dimensions for clarity of explanation.

### Configuration of Fluid Handling System

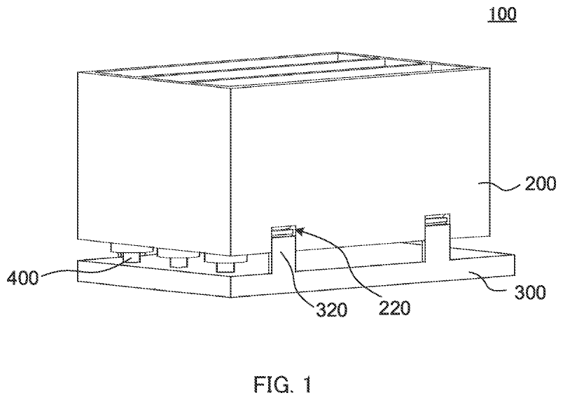

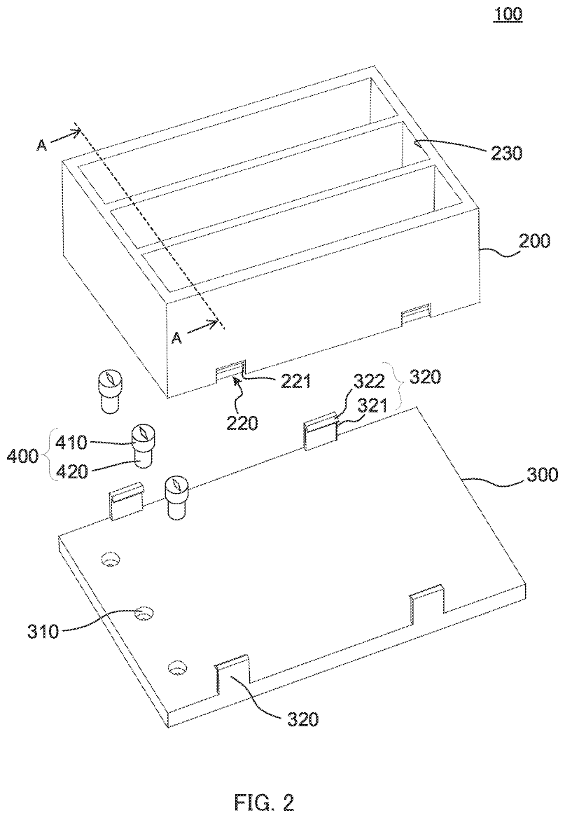

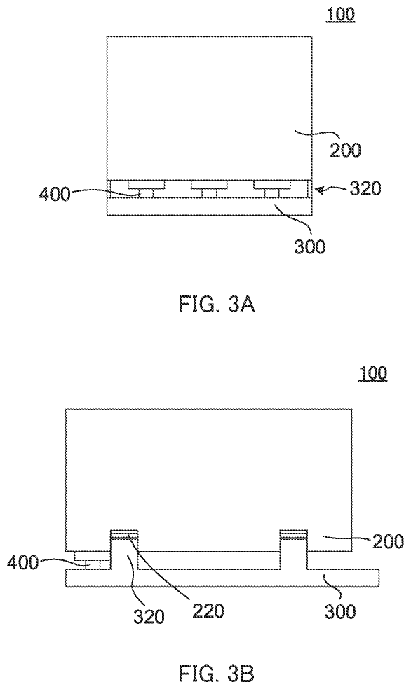

FIG. 1 is a perspective view of fluid handling system 100 according to an embodiment of the present invention. FIG. 2 is an exploded perspective view of fluid handling system 100. FIG. 3A is an exploded front view of fluid handling system 100, and FIG. 3B is a right side view of fluid handling system 100.

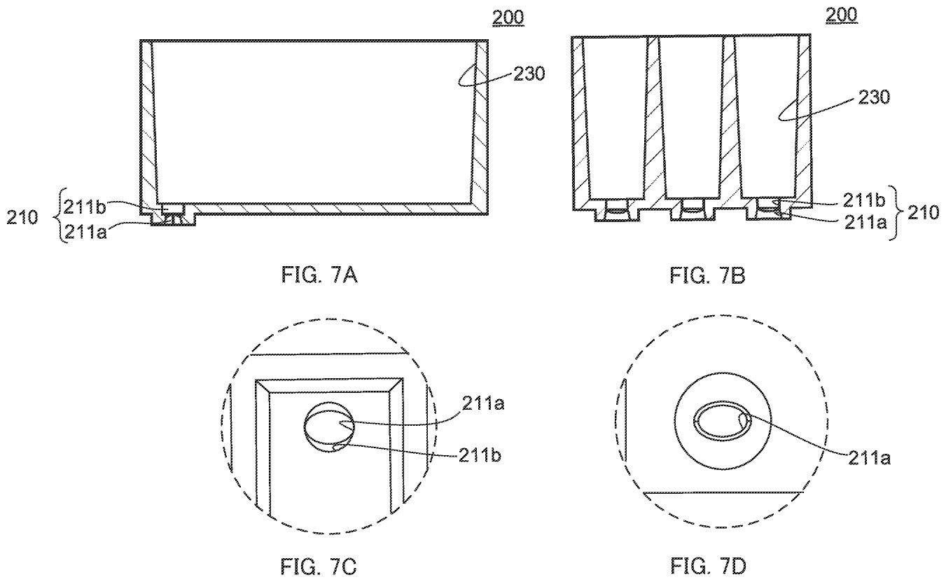

As illustrated in FIGS. 1 to 3B, fluid handling system 100 of the present embodiment includes reservoir 200 configured to house fluid, channel chip 300 disposed below reservoir 200 in the gravity direction, and cap 400 with first end portion 410 fit to opening 210 of reservoir 200 (see FIGS. 7A and 7B) and second end portion 420 connected to inlet 310 of channel chip 300. A combination of reservoir 200 and cap 400 is referred to as cartridge. Reservoir 200, channel chip 300 and cap 400 are assembled such that first engaging part 220 of reservoir 200 is engaged with second engaging part 320 of channel chip 300. It should be noted that fluid handling system 100 may be distributed with reservoir 200, channel chip 300 and cap 400 disassembled. In addition, reservoir 200 may be provided with a lid (not illustrated).

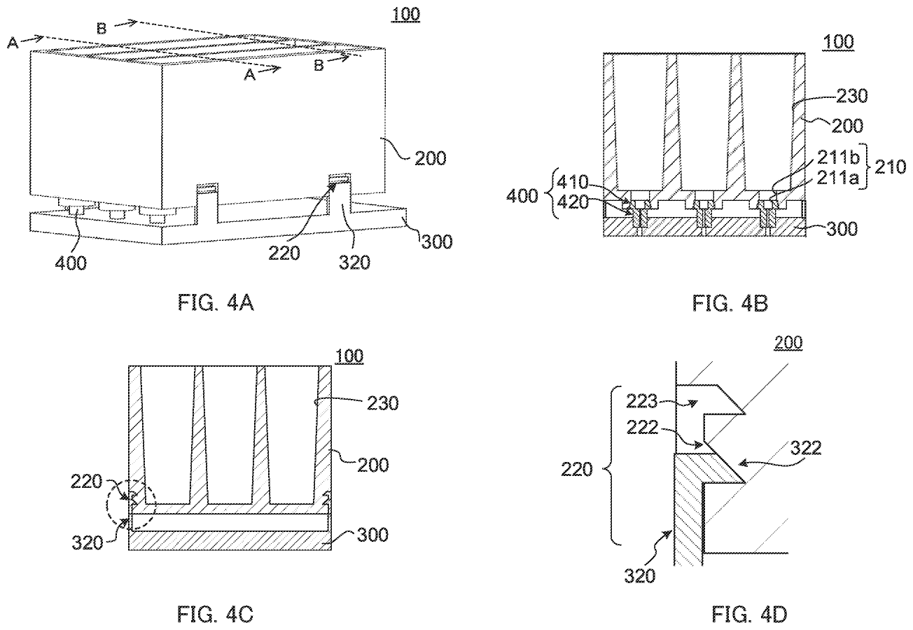

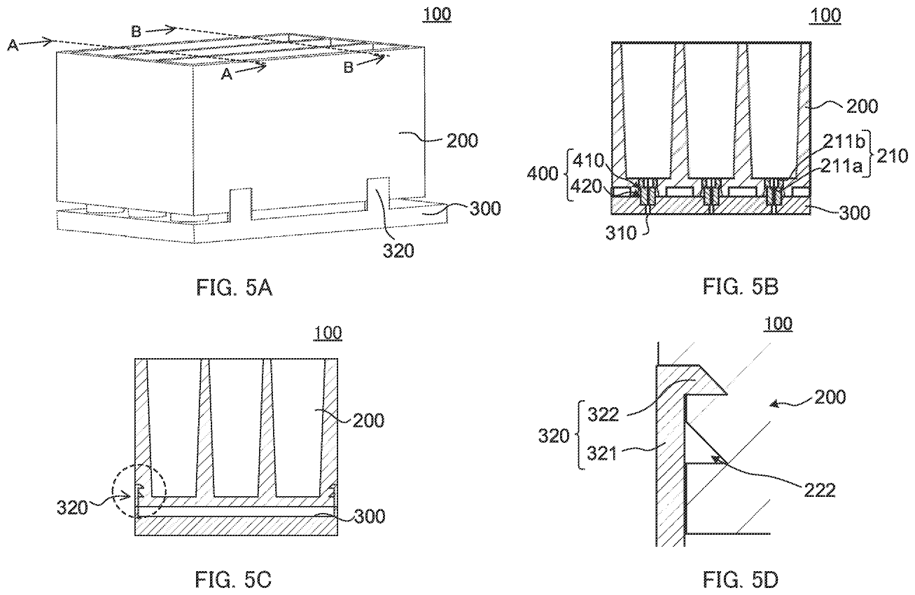

FIGS. 4A to 4D illustrate a configuration of a case where fluid is housed in housing part 230 of reservoir 200 (this state is hereinafter referred to also as “closed state”) in fluid handling system 100. In addition, FIGS. 5A to 5D illustrate a configuration of a case where fluid in housing part 230 of reservoir 200 is moved to inlet 310 of channel chip 300 (this state is hereinafter referred to also as “open state”). Note that FIGS. 4B and 5B are sectional views taken along line A-A of FIGS. 4A and 5A, respectively. FIGS. 4C and 5C are sectional views taken along line B-B of FIGS. 4A and 5A, respectively. FIGS. 4D and 5D are partially enlarged sectional views of the regions surrounded by the broken lines in FIGS. 4C and 5C, respectively.

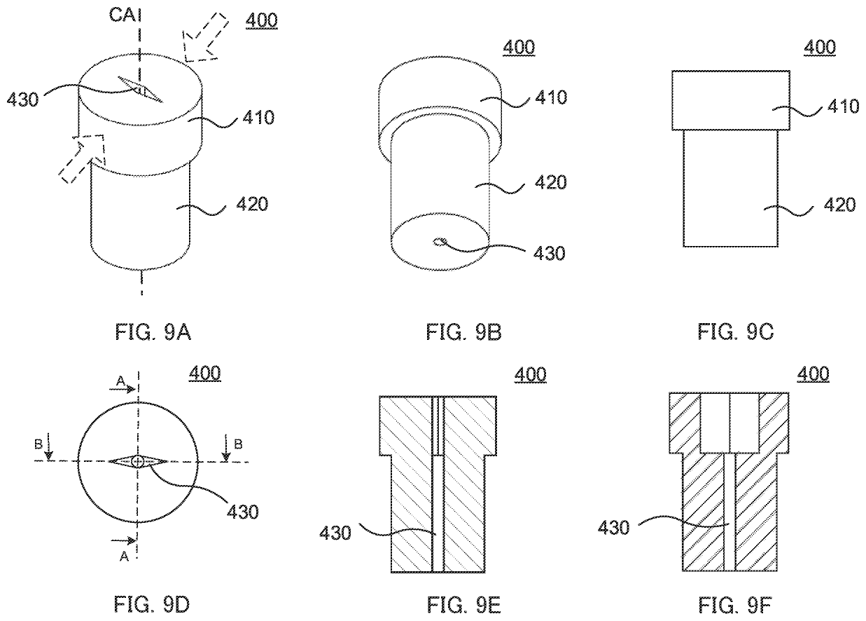

In fluid handling system 100 according to the present embodiment, when fluid is housed in housing part 230 of reservoir 200 (closed state), opening 210 of reservoir 200 presses a part of cap 400, and closes through hole 430 of cap 400 (see FIGS. 9A to 9F) as illustrated in FIG. 4B. That is, cap 400 serves as a stopper of opening 210 of reservoir 200.

On the other hand, as illustrated in FIGS. 5A and 5B, when at least one of reservoir 200 and channel chip 300 is moved such that reservoir 200 and channel chip 300 come close to each other, the pressing of opening 210 of reservoir 200 against cap 400 is released. As a result, through hole 430 of cap 400 is reset to the original shape, and through hole 430 serves as a channel that connects housing part 230 of reservoir 200 and inlet 310 of channel chip 300 (open state).

As is clear from comparison between FIGS. 4A, 4C and 4D and FIGS. 5A, 5C and 5D, in fluid handling system 100 according to the present embodiment, when at least one of reservoir 200 and channel chip 300 is moved to change the state from the closed state to the open state, the engaging state between first engaging part 220 of reservoir 200 and second engaging part 320 of channel chip 300 is changed.

Each member of fluid handling system 100 according to the present embodiment is elaborated below.

### Reservoir

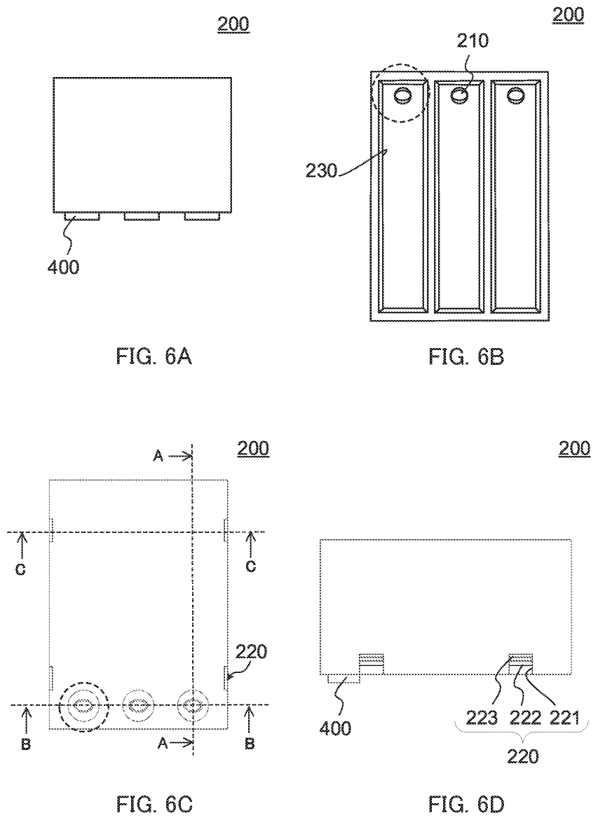

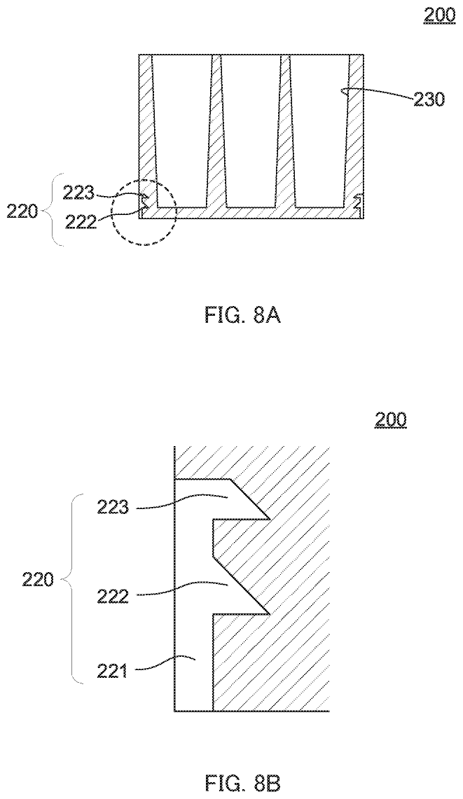

FIG. 6A is a front view of reservoir 200, FIG. 6B is a plan view of reservoir 200, FIG. 6C is a bottom view of reservoir 200, and FIG. 6D is a left side view of reservoir 200. FIG. 7A is a sectional view of reservoir 200 illustrated in FIG. 6C taken along line A-A, FIG. 7B is a sectional view of reservoir 200 illustrated in FIG. 6C taken along line B-B, FIG. 7C is a partially enlarged view of the region surrounded by the broken line in FIG. 6B, and FIG. 7D is a partially enlarged view of the region surrounded by the broken line in FIG. 6C. FIG. 8A is a sectional view taken along line C-C of FIG. 6C, and FIG. 8B is a partially enlarged view of the region surrounded by the broken line in FIG. 8A.

As illustrated in FIG. 6B, in the present embodiment, reservoir 200 includes three housing parts 230, three openings 210 disposed in the bottom of each housing part 230, and four first engaging parts 220. Note that the number of housing parts 230, the number of openings 210 and the number of first engaging parts 220 are not limited, and are appropriately selected in accordance with the use of fluid handling system 100. For example, a plurality of openings 210 may be disposed in one housing part 230. In addition, in the present embodiment, three housing parts 230 have the same shape and three openings 210 have the same shape, but they may have different shapes.

In the present embodiment, housing part 230 is a bottomed recess with a substantially cuboid shape. It should be noted that the shape of housing part 230 is not limited as long as fluid of a desired amount can be contained, and may be, for example, a recess with a truncated pyramid shape, a columnar shape, a truncated cone shape and the like. In addition, in the present embodiment, the bottom surface of housing part 230 is set to be approximately parallel with the surface of the housed fluid, but the bottom surface may be tilted in part or in its entirety such that it becomes deeper toward opening 210.

Opening 210 is a hole that is formed in the bottom of housing part 230 and communicates between the inside of housing part 230 and the outside of reservoir 200. First end portion 410 of cap 400 is fit to opening 210.

Here, as illustrated in FIGS. 7A to 7D, opening 210 has a shape in which pressing region 211a with a substantially elliptical columnar opening, and open region 211b with a substantially columnar opening are continuously provided.

Pressing region 211a is a region for housing first region 410 of cap 400 when setting fluid handling system 100 to a closed state, and is a region for pressing a part of cap 400 (first region 410) toward the central axis of cap 400. In the present embodiment, the shape of first region 410 of cap 400 is a columnar shape, and the opening shape of pressing region 211a is a substantially elliptical columnar shape. Therefore, when columnar first region 410 of cap 400 is housed in pressing region 211a, the exterior wall of pressing region 211a presses first region 410 of cap 400 toward central axis CA of cap 400. As a result, through hole 430 of first region 410 of cap 400 is closed, and outflow of fluid from through hole 430 of cap 400 is suppressed.

Note that it suffices that pressing region 211a has a shape with which through hole 430 is closed at least at a part of first region 410 of cap 400 when first region 410 of cap 400 is housed. For example, pressing region 211a may have a constant opening cross-sectional area from outside of reservoir 200 to open region 211b side. In the present embodiment, pressing region 211a has a tapered shape whose opening cross-sectional area decreases from the outside of reservoir 200 toward open region 211b side for the sake of the ease of fitting of cap 400.

On the other hand, when fluid handling system 100 is set to an open state, second region 420 of cap 400 is housed in pressing region 211a. For this reason, pressing region 211a has a shape with which through hole 430 is not closed at second region 420 when second region 420 of cap 400 is housed.

Open region 211b is a region for housing first region 410 of cap 400 when fluid handling system 100 is set to an open state, and is a region where the pressing force toward central axis CA of cap 400 when first region 410 of cap 400 is housed is smaller than that of the above-described pressing region 211a. In the present embodiment, open region 211b is provided as a region having an opening cross-sectional area wider than that of pressing region 211a, and thus the pressure toward the central axis of cap 400 is set to a small value. In addition, in the present embodiment, open region 211b is similar in shape to the external shape of first region 410 of cap 400 (columnar shape). When first region 410 of cap 400 is housed in open region 211b with such a columnar shape, first region 410 of cap 400 is reset to the original columnar shape with its flexibility. As a result, through hole 430 is opened, and the fluid can pass inside through hole 430 of cap 400.

It should be noted that when a gap is formed between open region 211b and first region 410 of cap 400, the fluid may outflow to the outside of housing part 230 through the gap. In view of this, in the present embodiment, the opening diameter (diameter) of open region 211b is set to be equal to or smaller than the diameter of columnar first region 410 of cap 400.

First engaging part 220 is formed at a position corresponding to second engaging part 320 of channel chip 300, and is engaged by means of second engaging part 320 of channel chip 300. In the present embodiment, four first engaging parts 220 are formed in side walls that constitute the housing part of reservoir 200. In fluid handling system 100 according to the present embodiment, while first engaging part 220 of reservoir 200 and second engaging part 320 of channel chip 300 are engaged with each other in both the closed state and open state, the engaging state between first engaging part 220 of reservoir 200 and second engaging part 320 of channel chip 300 differs between the closed state and the open state. Specifically, in the closed state, the engaging state between first engaging part 220 of reservoir 200 and second engaging part 320 of channel chip 300 is the first engaging state illustrated in FIGS. 4A to 4D, whereas in the open state, the engaging state between first engaging part 220 of reservoir 200 and second engaging part 320 of channel chip 300 is the second engaging state illustrated in FIGS. 5A to 5D. In the second engaging state illustrated in FIGS. 5A to 5D, channel chip 300 is moved to reservoir 200 side in comparison with the first engaging state illustrated in FIGS. 4A to 4D. In this manner, cap 400 is pushed by channel chip 300 toward housing part 230 side, and first region 410 of cap 400 is moved from pressing region 211a to open region 211b.

The shape of first engaging part 220 is not limited the above-mentioned function can be ensured, and is set in accordance with the shape of second engaging part 320 of channel chip 300. In the present embodiment, first engaging part 220 includes guide groove 221, first recess 222, and second recess 223. Guide groove 221 is a groove extending along the gravity direction, to which guide protrusion 321 of second engaging part 320 of channel chip 300 is fit in a slidable manner. First recess 222 and second recess 223 are disposed in guide groove 221, and engaged by means of claw 322 of second engaging part 320 of channel chip 300. First recess 222 is a recess for setting the engaging state between first engaging part 220 and second engaging part 320 to the first engaging state, and second recess 223 is a recess for setting the engaging state between first engaging part 220 and second engaging part 320 to the second engaging state. In addition, at least first recess 222 has a shape that allows for disengagement of engaged claw 322. In the present embodiment, first recess 222 is disposed below second recess 223 (i.e., on channel chip 300 side) in the gravity direction.

The material of reservoir 200 is not limited as long as it is not eroded by fluid housed in housing part 230. Examples of the material of reservoir 200 include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers. In addition, reservoir 200 may be molded by injection molding and the like, for example.

### Cap

FIGS. 9A to 9F illustrate a configuration of cap 400. FIG. 9A is a top perspective view, FIG. 9B a bottom perspective view, FIG. 9C is a front view, FIG. 9D is a plan view, FIG. 9E is a sectional view taken along line A-A of FIG. 9D, and FIG. 9F is a sectional view taken along line B-B of FIG. 9D.

As illustrated in FIGS. 9A to 9F, in the present embodiment, cap 400 is a substantially columnar member, and includes through hole 430 that is approximately parallel to its central axis CA. In addition, cap 400 includes columnar first region 410 where through hole 430 is closed when housed in pressing region 211a of opening 210 of reservoir 200 and pressed by the exterior wall of opening 210 (pressing region 211a), and columnar second region 420 with a cross-sectional area in a direction perpendicular to central axis CA of cap 400 smaller than first region 410. In addition, in cap 400, the bottom of first region 410 and the top of second region 420 are coupled with each other.

Here, the diameter of first region 410 is appropriately set in accordance with the opening width and opening cross-sectional area of opening 210 (pressing region 211a and open region 211b) of reservoir 200. In addition, the shape of through hole 430 in a direction orthogonal to central axis CA in first region 410 is not limited as long as it is closed with no gap when first region 410 is housed in pressing region 211a of reservoir 200, and may be, for example, a slit shape. Note that “slit shape” as used herein means a gap elongated in one direction in a cross-section perpendicular to central axis CA of cap 400, and is a gap that is closed in a linear shape when pressed along the minor axis direction from both sides. In the present embodiment, as illustrated in FIG. 9A, in a direction orthogonal to central axis CA, through hole 430 has a rhombic shape with one diagonal sufficiently longer than the other.

Here, the opening width and opening shape of through hole 430 in first region 410 in a direction orthogonal to central axis CA are appropriately selected in accordance with the type of fluid and the desired flow rate of fluid.

In addition, the height of first region 410 is not limited, and is appropriately selected in accordance with the shape of opening 210 of reservoir 200 (pressing region 211a and open region 211b). It should be noted that, from the view point of causing outflow of the fluid housed in housing part 230 with no residue, it is desirable to set a height with which the first end portion (the end portion on first region 410 side) of cap 400 does not protrude into housing part 230 when first region 410 is housed in open region 211b of reservoir 200. That is, preferably, the height of first region 410 is set to a value equal to or smaller than the height of open region 211b.

On the other hand, the diameter of second region 420 is appropriately set in accordance with the opening width and opening cross-sectional area of pressing region 211a of reservoir 200. In addition, the opening width and opening shape of through hole 430 of second region 420 in a direction orthogonal to central axis CA are appropriately selected in accordance with the type of fluid and the desired flow rate of fluid, and may be the same as or different from the shape of through hole 430 of first region 410. In the present embodiment, the cross-sectional shape of through hole 430 of second region 420 in a direction orthogonal to central axis CA is a circular shape.

In addition, the height of second region 420 is set to a height with which a part of second region 420 protrudes from opening 210 of reservoir 200 when first region 410 is housed in open region 211b of reservoir 200. As described above, fluid handling system 100 of the present embodiment is used in the state where the second end portion (the end portion on the second region side) of cap 400 is connected to inlet 310 of channel chip 300.

The material of cap 400 is not limited as long as the material has flexibility, and may be selected from publicly known elastomer resins. While elastomer resins include thermoplastic resins and thermosetting resins, cap 400 may be composed of any of them. Examples of heat-curable elastomer resins that can be used for cap 400 include polyurethane resins, and poly silicone resins the like, and examples of thermoplastic elastomer resins include styrene resins, olefin resins, and polyester resins. Specific examples of olefin resins include polypropylene resin. In addition, first region 410 and second region 420 of cap 400 may be composed of the same material, or different materials. It should be noted that from a view point of the ease of manufacture and the like, it is preferable to they are composed of the same material. In addition, cap 400 may be molded by injection molding and the like, for example.

### Channel Chip

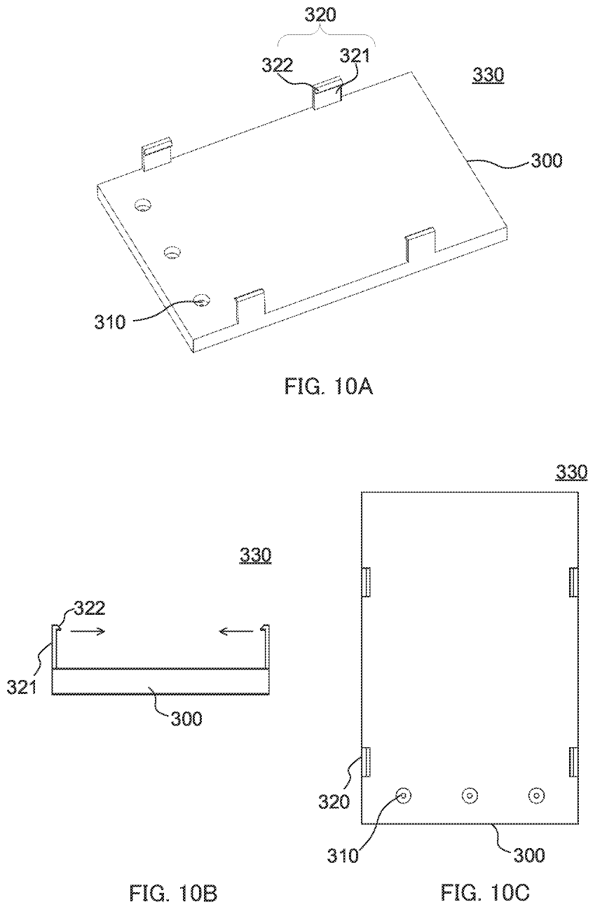

FIGS. 10A to 10C illustrate a configuration of channel chip 300. FIG. 10A is a perspective view, FIG. 10B is a front view, and FIG. 10C is a plan view.

As illustrated in FIGS. 10A to 10C, channel chip 300 includes three inlets 310 and four second engaging parts 320. Channel chip 300 further includes therein a channel that connects three inlets 310. In the present embodiment, two inlets 310 of three inlets 310 are used as first inlet 331 and second inlet 332 for introducing the fluid into channel chip 300, and the remaining one inlet 310 is used as outlet 333 for discharging the fluid out of channel chip 300.

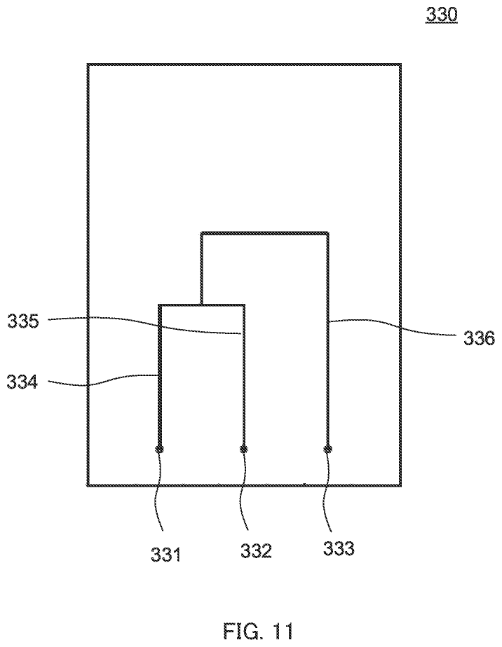

In the present embodiment, channel chip 300 is composed of main body 330 and a film (not illustrated in the drawing) joined to one surface (hereinafter referred to as “bottom surface”) of main body 330. FIG. 11 is a bottom view of main body 330. As illustrated in FIG. 11, main body 330 includes first inlet 331 and second inlet 332 for introducing the fluid into channel chip 300, and outlet 333 for discharging the fluid from channel chip 300. First inlet 331, second inlet 332, and outlet 333 are through holes disposed in main body 330.

In addition, main body 330 further includes, as bottomed recesses formed in the surface (bottom surface) of main body 330 to which the film (not illustrated in the drawing) is bonded, first groove part 334 with one end connected to first inlet 331, second groove part 335 with one end connected to second inlet 332, and third groove part 336 with one end connected to first groove part 334 and second groove part 335 and the other end connected to outlet 333. In channel chip 300, the region surrounded by the film and first groove part 334 serves as the first channel, the region surrounded by the film and second groove part 335 serves as the second channel, and the region surrounded by the film and third groove part 336 serves as the third channel of the fluid.

In channel chip 300, for example, first fluid (in the present embodiment, a sample) is introduced from first inlet 331, and second fluid (in the present embodiment, a reagent) is introduced from second inlet 332. The fluids are introduced into the third channel through the first channel and second channel so as to cause a reaction at the third channel Thereafter, for example, the reactant can be moved from outlet 333 to reservoir 200 side through cap 400.

Note that examples of the material of main body 330 include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers. In addition, main body 330 including the above-mentioned components may be molded by injection molding and the like, for example.

Here, main body 330 may be or may not be optically transparent. For example, in the case where fluid is observed from the surface on the side opposite to the front surface of main body 330, the material is selected such that main body 330 is optically transparent.

On the other hand, the film (not illustrated in the drawing) may be a flat film that covers main body 330. It suffices that the film is composed of a material that is not eroded by the fluid introduced in channel chip 300, and its thickness and the like are appropriately selected. Examples of the material of the film include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers.

In the case where fluid is observed and/or analyzed from the film side in the state where the fluid is housed in the third channel, the material of the film is selected such that the film is optically transparent. It should be noted that, for example, in the case where fluid is observed from the side opposite to the front surface of main body 330, and/or the case where the observation of fluid is not performed, the film may not be optically transparent.

In addition, main body 330 and the film may be joined by publicly known methods such as heat fusing, and bonding with adhesive agents.

As described above, channel chip 300 includes four second engaging parts 320. In the present embodiment, second engaging part 320 is formed in main body 330.

As illustrated in FIGS. 10A to 10C, second engaging part 320 is formed at a position corresponding to first engaging part 220 of reservoir 200, and is engaged with first engaging part 220 of reservoir 200. In the present embodiment, four second engaging parts 320 are formed to protrude from the top surface of main body 330 of channel chip 300. As described above, in fluid handling system 100 according to the present embodiment, in the closed state, the engaging state between first engaging part 220 of reservoir 200 and second engaging part 320 of channel chip 300 is set to the first engaging state illustrated in FIGS. 4A to 4D; whereas in the open state, the engaging state between first engaging part 220 of reservoir 200 and second engaging part 320 of channel chip 300 is set to the second engaging state illustrated in FIGS. 5A to 5D.

The shape of second engaging part 320 is not limited as long as the above-mentioned function can be ensured, and is set in accordance with the shape of first engaging part 220 of reservoir 200. In the present embodiment, second engaging part 320 includes guide protrusion 321 and claw 322. Guide protrusion 321 is a protrusion protruding toward reservoir 200 side, and is fit in guide groove 221 of first engaging part 220 of reservoir 200 in a slidable manner. Claw 322 is disposed at an end of guide protrusion 321, and is engaged with first recess 222 or second recess 223 of first engaging part 220 of reservoir 200. The shape of claw 322 is not limited as long as it be can engaged with first recess 222 and second recess 223 after being engaged with first recess 222. In the present embodiment, as illustrated in FIGS. 4D and 5D, an inclined surface is provided in the upper part of claw 322, and an inclined surface is provided also in an upper part of first recess 222. In addition, the shape of guide protrusion 321 is not limited as long as it can fit in guide groove 221 in a slidable manner. The length of guide protrusion 321 is set such that reservoir 200, channel chip 300 and cap 400 are positioned so as to set fluid handling system 100 to the closed state when claw 322 is engaged with first recess 222 of first engaging part 220; whereas reservoir 200, channel chip 300 and cap 400 are positioned so as to set fluid handling system 100 to the open state when claw 322 is engaged with second recess 223 of first engaging part 220.

### Usage of Fluid Handling System A fluid handling method using fluid handling system 100 according to the present embodiment is described below.

First, as illustrated in FIGS. 1, 3A, 3B and FIGS. 4A to 4D, opening 210 of reservoir 200 and inlet 310 of channel chip 300 are disposed opposite to each other. Then, the first end portion (first region 410) of cap 400 is housed in pressing region 211a of opening 210 of reservoir 200. To be more specific, first region 410 of cap 400 is housed in pressing region 211a of reservoir 200 while it is pressed in two directions (the directions indicated by the arrows in FIG. 9A) toward its central axis CA and along the minor axis direction of the rhombus. On the other hand, the second end portion (second region 420) of cap 400 is connected to inlet 310 of channel chip 300.

In this state, the engaging state between first engaging part 220 of reservoir 200 and second engaging part 320 of channel chip 300 is set to the first engaging state illustrated in FIGS. 4A to 4D. Specifically, as illustrated in FIG. 4D, claw 322 of second engaging part 320 of channel chip 300 is engaged with first recess 222 of first engaging part 220 of reservoir 200. As a result, fluid handling system 100 is maintained in the closed state.

In the case where fluid handling system 100 is set to the closed state in the above-described manner, desired fluid is supplied in housing part 230 of reservoir 200. Note that in the case where the above-described channel chip 300 is used, one housing part 230 of three housing parts 230 of reservoir 200 is filled with the sample, another housing part 230 is filled with the reagent, and the remaining housing part 230 is set as a part for fluid collection, or in other words, set to an empty state. It should be noted that all housing parts may be filled with the fluid depending on the type of channel chip 300. In addition, various types of fluid (such as reagent and sample) may be supplied in reservoir 200 in advance.

The type of the fluid to be housed in housing part 230 of reservoir 200 is not limited as long as it can pass through through hole 430 of cap 400. The fluid may contain a single component or a plurality of components. In addition, the fluid is not limited to liquid, and may be, for example, a solvent in which a solid component is dispersed. In addition, the fluid may be a solvent in which droplets (liquid droplets) and the like incompatible with the solvent are dispersed, and the like.

When the fluid is moved from reservoir 200 into channel chip 300 in fluid handling system 100, at least one of reservoir 200 and channel chip 300 is moved such that reservoir 200 and channel chip 300 are brought closer to each other as illustrated in FIGS. 5A to 5D, or more specifically, claw 322 of second engaging part 320 is engaged with second recess 223 of first engaging part 220. In this manner, first region 410 of cap 400 is pushed into open region 211b of opening 210 of reservoir 200. As a result, through hole 430 of first region 410 and second region 420 of cap 400 is opened, and the fluid can pass through through hole 430 of cap 400. That is, fluid handling system 100 is set to the open state, and that state is maintained.

Note that housing part 230 in which the fluid is housed may be pressurized or a specific housing part 230 may be suctioned as necessary for the purpose of facilitating the flow of the fluid in through hole 430 of cap 400. In addition, the fluid may be moved using capillarity.

### Effect

With fluid handling system 100 according to the present embodiment, the closed state can be easily set by setting fluid handling system 100 to the first engaging state. In addition, the open state can be easily set by setting fluid handling system 100 to the second engaging state by moving at least one of reservoir 200 and channel chip 300. Thus, without using large-scale devices, the desired fluid can be supplied to channel chip 300.

In addition, in fluid handling system 100 according to the present embodiment, reservoir 200 and channel chip 300 can be moved relative to each other such that fluid handling system 100 is switched from the closed state to the open state by sliding guide protrusion 321 of second engaging part 320 of channel chip 300 in guide groove 221 of first engaging part 220 of reservoir 200. Thus, buckling of cap 400 due to a positional displacement of reservoir 200 and channel chip 300 in the horizontal direction can be suppressed. In addition, since first engaging part 220 of reservoir 200 and second engaging part 320 of channel chip 300 are engaged with each other, disassembling of reservoir 200, channel chip 300 and cap 400 can be suppressed.

In addition, with fluid handling system 100 according to the present embodiment, various types of fluid can be supplied into channel chip 300 by only pushing one of reservoir 200 and channel chip 300 toward the other. In addition, with fluid handling system 100, collection and the like of fluid at reservoir 200 can be achieved, and inspection and analysis of various types of fluid can be efficiently performed.

### Modification

Note that while the example in which first engaging part 220 of reservoir 200 includes a recess, and second engaging part 320 of channel chip 300 includes the claw that engages with the recess is described in the embodiment, the present invention is not limited to this. For example, second engaging part 320 of channel chip 300 may include a recess, and first engaging part 220 of reservoir 200 may include a claw that engages with the recess.

This application is entitled to and claims the benefit of Japanese Patent

Application No. 2019-016903 filed on Feb. 1, 2019, the disclosure each of which including the specification, drawings and abstract is incorporated herein by reference in its entirety.

### INDUSTRIAL APPLICABILITY

For example, the fluid handling system according to the present invention is applicable to inspection and analysis of various types of fluid and the like.

### REFERENCE SIGNS LIST

100 Fluid handling system
200 Reservoir
210 Opening
211a Pressing region
211b Open region
220 First engaging part
221 Guide groove
222 First recess
223 Second recess
230 Housing part
300 Channel chip
310 Inlet
320 Second engaging part
321 Guide protrusion
322 Claw
330 Main body
331 First inlet
332 Second inlet
333 Outlet
334 First groove part
335 Second groove part
336 Third groove part
400 Cap
410 First end portion (First region)
420 Second end portion (Second region)
430 Through hole

What is claim is:

1. A fluid handling system comprising:
a reservoir including a housing part configured to house fluid, an opening disposed in a bottom of the housing part and configured to communicate between the housing part and outside, and a first engaging part;
a channel chip including an inlet disposed opposite to the opening of the reservoir and configured to introduce fluid, and a second engaging part configured to engage with the first engaging part; and
a cap made of elastomer with flexibility, the cap including a first end portion configured to be fit in the opening of the reservoir, a second end portion configured to be connected to the inlet of the channel chip, and a through hole configured to connect the first end portion and the second end portion,
wherein a closed state is set when the opening of the reservoir presses a part of the cap in such a manner as to close the through hole, the closed state being a state where fluid in the housing part does not move to the inlet of the channel chip through the through hole of the cap,
wherein an open state is set when the cap is moved to a side of the housing part relative to a position of the closed state and pressing of the opening against the cap is released, the open state being a state where the fluid in the housing part moves to the inlet of the channel chip through the through hole of the cap,
wherein in the closed state, the first engaging part of the reservoir and the second engaging part of the channel chip are in a first engaging state,
wherein in the open state, the first engaging part of the reservoir and the second engaging part of the channel chip are in a second engaging state, and
wherein when at least one of the reservoir and the channel chip is moved in such a manner that the reservoir and the channel chip are brought closer to each other, an engaging state of the first engaging part and the second engaging part is switched from the first engaging state to the second engaging state.

2. The fluid handling system according to claim 1,
wherein one of the first engaging part and the second engaging part includes a first recess and a second recess;
wherein the other of the first engaging part and the second engaging part includes a claw;
wherein in the first engaging state, the claw engages with the first recess; and
wherein in the second engaging state, the claw engages with the second recess.

3. The fluid handling system according to claim 2,
wherein the one of the first engaging part and the second engaging part includes a guide groove;
wherein the other of the first engaging part and the second engaging part includes a guide protrusion;
wherein the first recess and the second recess are disposed in the guide groove;
wherein the claw is disposed on the guide protrusion; and
wherein the guide protrusion is fit to the guide groove in a slidable manner.

4. The fluid handling system according to claim,
wherein the first engaging part includes the first recess and the second recess; and
wherein the second engaging part includes the claw.

5. A cartridge configured to be used in combination with a channel chip including an inlet configured to introduce fluid and a second engaging part, the cartridge comprising:
a reservoir including a housing part configured to house fluid, an opening disposed in a bottom of the housing part and configured to communicate between the housing part and outside, and a first engaging part configured to be engaged with the second engaging part; and
a cap made of elastomer with flexibility, the cap including a first end portion configured to be fit in the opening of the reservoir, a second end portion configured to be connected to the inlet of the channel chip, and a through hole configured to connect the first end portion and the second end portion,
wherein a closed state is set when the opening of the reservoir presses a part of the cap in such a manner as to close the through hole, the closed state being a state where fluid in the housing part does not move to the inlet of the channel chip through the through hole of the cap,
wherein an open state is set when the cap is moved to a side of the housing part relative to a position of the closed state and pressing of the opening against the cap is released, the open state being a state where the fluid in the housing part moves to the inlet of the channel chip through the through hole of the cap,
wherein the first engaging part of the reservoir is configured such that in the closed state, the first engaging part and the second engaging part of the channel chip are in a first engaging state,
wherein the first engaging part of the reservoir is configured such that in the open state, the first engaging part and the second engaging part of the channel chip are in a second engaging state, and
wherein the first engaging part is configured such that when at least one of the reservoir and the channel chip is moved in such a manner that the reservoir and the channel chip are brought closer to each other, an engaging state of the first engaging part and the second engaging part is switched from the first engaging state to the second engaging state.
